(19) United States
(12) Patent Application Publication
(10) Pub. No.: US 2026/0309250 A1
(43) Pub. Date: Oct. 8, 2026

(54) ACTUATOR WITH ELECTRIC MOTOR

(71) Applicant: AUMA Riester GmbH & Co. KG, Müllheim (DE)

(72) Inventor: Rudolf MORLANG, Villingen-Schwenningen (DE)

(73) Assignee: AUMA Riester GmbH & Co.KG, Müllheim (DE)

(21) Appl. No.: 19/479,010

(22) PCT Filed: May 7, 2024
(86) PCT No.: PCT/EP2024/062615

§ 371 Date: Oct. 27, 2025

(30) Foreign Application Priority Data
May 10, 2023 (DE) 102023112298.3

(51) Int. Cl. F16K 31/04; F16K 31/50; F16K 31/53; F16K 37/00

(52) U.S. Cl. CPC F16K 31/047; F16K 31/508; F16K 31/53; F16K 37/0041

(57) ABSTRACT

The invention relates to an actuator (1) for automation technology designed to actuate a fitting, such as a valve, wherein the actuator has a force measuring device (70), which force measuring device is designed to measure a mechanical propelling force, causing the movement of an output, from a deflection of a resiliently mounted device from a resting position, wherein the electronic operating circuit is designed to derive a drive efficiency of the actuator from force measurement values relating to the output movement and from measured values of a mechanical motor force derived from motor current and/or motor voltage.

### CROSS-REFERENCE TO RELATED APPLICATIONS

This application is a 371 National Phase of International Application No. PCT/EP 2024/062615, filed May 7, 2024, which claims priority from German Patent Application No. 10 2023 112 298.3, filed May 10, 2023, both of which are incorporated herein by reference as if fully set forth.

### TECHNICAL FIELD

The invention relates to an actuator in automation technology with an electric motor for operating a fitting.

### BACKGROUND

Such actuators are also used in automation technology to operate fittings such as, for example, valves. For example, DE102019134805A1 shows an actuator in which a motor current is used to determine a motor temperature.

In actuators with electric motors, the drive train of an actuator is subjected to heavy loads over time, so that wear and tear reduces the efficiency of the actuator.

### SUMMARY

It is the object of the invention to propose an actuator in which the efficiency of the actuator can be measured.

The object is solved by an actuator having one or more of the features disclosed herein.

An actuator according to the invention for automation technology, designed to actuate a fitting such as a valve, comprises:
A housing with a housing wall;
An electric motor;
An electronic operating circuit for operating the electric motor;
An output having an output axle or output shaft, which output is designed to actuate a fitting by means of an axial movement or a rotary movement of the output axle or output shaft;
A gearbox designed to transmit a force or torque to the output, wherein the gearbox has a plurality of toothed parts, such as gearwheels or worms, which are mounted by means of toothed part bearings, such as gear axles or gear shafts;
wherein the electric motor, gearbox, and electronic operating circuit are arranged in the housing,
wherein the electric motor is designed to move the output linearly or rotatably by means of the gearbox,
wherein the actuator comprises a device which is spring-mounted in the housing by means of a spring device, which spring-mounted device is formed by the output or by a toothed part or by a toothed part bearing,
wherein the actuator has a force measuring device, which force measuring device is designed to measure a mechanical propulsive force causing the movement of the output from a deflection of the spring-mounted device from a rest position, and
wherein the electronic operating circuit is designed to derive a drive efficiency of the actuator from force measurement values relating to the drive movement and from measured values of a mechanical motor force derived from the motor current and/or motor voltage.

By comparing a propulsive force required for a movement of the output, which is independent of an efficiency of the actuator, and a motor force applied or generated by the electric motor, a drive efficiency of the actuator can be inferred. Wear on the actuator can be determined from the measured drive efficiency, in particular from a change in the drive efficiency over time. If wear is detected or there is a long-term change in efficiency, the electronic operating circuit can be set up to issue a warning message, for example. In this way, a plant operator can replace an affected actuator if maintenance can be carried out on a plant without major inconvenience. This prevents expensive emergency shutdowns or malfunctions of the plant.

In one design, the force measuring device is set up to convert a deflection of the spring-mounted device from its rest position against the spring device into a deflection-dependent measuring signal of an electronic measured variable such as inductance, capacitance, current or voltage,
wherein the force measuring device or the electronic operating circuit is designed to derive or calculate a measured value for the propulsive force from the measuring signal.

In one design, the force measuring device has a sensor for generating the measuring signal, for example with a coil, a capacitor or a capacitor plate or a photodiode,
wherein the force measuring device has a sensing arm, which is set up to be moved by an axial or rotary movement of the spring-mounted device and thereby to cause a change in the measuring signal of the electronic measured variable.

In one design, the force measuring device comprises a lever device with a lever bearing and with a first end and an opposite second end relative to the lever bearing,
wherein the sensing arm forms the first end, wherein the second end is set up to influence a measured value of the electronic measured variable in a position-dependent manner,
wherein a lever length of the first end is in particular smaller than a lever length of the second end.

A smaller lever length of the first end allows a small deflection of the spring-mounted device to be translated into a larger change in the measuring signal.

In one design, the sensor has a front surface, wherein the second end is set up to cover the front surface at least partially, wherein a coverage portion depends on the propulsive force against the spring device,
wherein the sensor has a coil, wherein the second end is permanently magnetic or electrically conductive, wherein the second end is set up to influence an inductance of the coil and the second end,
or wherein the sensor has a capacitor plate, wherein the second end is electrically conductive, wherein the second end is set up to influence a capacitance of the capacitor plate and the second end,
or wherein the sensor comprises a photodiode, wherein the second end is set up to attenuate or block light incident thereon, for example, from an LED.

In one design, the second end is disc-shaped.

In one design, measured values of the measuring signal assume a value range with a maximum value and a minimum value, wherein a measured value of the measuring signal in a force-free state of the output assumes a value which is less than 30%, and in particular less than 25%, and preferably less than 20% of a difference between the maximum value and the minimum value from a mean value of the value range.

In this way, a deflection of the spring-mounted device in both directions can be detected with sufficient detection clearance.

In one design, the spring device has at least one first spring element and at least one second spring element,
wherein the at least one first spring element is set up to exert a force against a deflection of the output from the rest position in a first direction,
wherein the at least one second spring element is set up to exert a force against a deflection of the output from the rest position in a second direction opposite to the first direction.

In one design, the spring-mounted device is formed by the output, wherein a cross-sectional plane of the first spring element and a cross-sectional plane of the second spring element are spaced apart by a distance of less than 30%, and in particular less than 25%, and preferably less than 20% of a diameter of the first spring element or of the second spring element.

In this way, the resilient bearing of the spring-mounted device can be designed in a compact manner.

In one design, the output axle is designed as a threaded spindle,
wherein the threaded spindle is fixed in rotation,
wherein the output has a spindle nut,
wherein the electric motor is set up to drive the spindle nut rotatably by means of the gearbox and thereby to move the threaded spindle axially,
wherein the output is spring-mounted in the housing in an axial direction of the threaded spindle by means of the spring device.

In one design, the spindle nut is mounted radially by means of a rolling bearing, which rolling bearing is at least partially arranged in a cylindrical recess of the housing wall,
wherein the cylindrical recess provides a stop for the rolling bearing against movement in the direction of a side of the cylindrical recess facing away from the housing,
wherein the rolling bearing contacts the stop when the drive is in the rest position when driven and/or is pretensioned against the stop,
wherein the at least one first spring element and the at least one second spring element act against the rolling bearing on a side of the rolling bearing facing the housing.

This contributes to a compact design of the actuator.

In one design, the actuator has a spring plate fixed in the housing with a central opening, through which opening the spindle nut is guided,
wherein the spindle nut has a radial shaped part, in particular a collar, on a side of the spring plate facing away from the housing, which is designed to act directly or indirectly as a stop against the spring plate,
wherein the spring plate is designed as one of the at least one first spring elements.

This contributes to a compact design of the actuator.

In one design, the spring plate is arranged outside the cylindrical recess, wherein the radial shaped part acts against the spring plate via the rolling bearing.

In one design, the gearbox has a first toothed element, such as a gearwheel, which is rotatably connected to the spindle nut,
wherein the spring device has at least one disc spring, which at least one disc spring surrounds the spindle nut and is designed as at least one of the at least one second spring element,
wherein the at least one disc spring is arranged and clamped between the first toothed element and the rolling bearing.

### BRIEF DESCRIPTION OF THE DRAWINGS

The invention is described below with reference to exemplary embodiments.

FIG. 1 shows a cross-section through an exemplary actuator according to the invention.

FIG. 2 shows an enlarged section of the actuator shown in FIG. 1.

FIG. 3 shows a cross-section of an exemplary actuator according to the invention.

FIGS. 4A and 4B show sensors of an actuator according to the invention.

### DETAILED DESCRIPTION

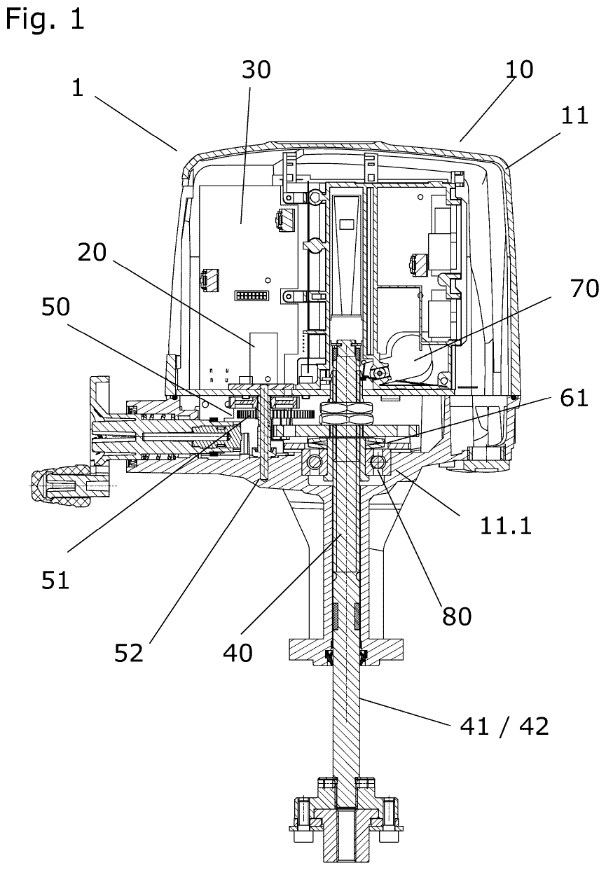

FIG. 1 shows a cross-section of an exemplary actuator 1 according to the invention, comprising a housing 10 with a housing wall 11, wherein an electric motor 20, an electronic operating circuit 30 for operating the electric motor, a gearbox 50, and an output 40 are arranged in the housing of the actuator. The output has an output axle 41 or output shaft 42, wherein the output is designed to actuate a valve by means of an axial movement or a rotary movement of the output axle or output shaft. The gearbox 50 is designed to transmit a force or torque from the electric motor to the output and has gear parts 51, such as gearwheels 51.1 or worms 51.2, which are mounted on toothed part bearings 52, such as gear axles 52.1 or gear shafts 52.2. The electric motor is designed to move the output axially or rotationally. The actuator has a spring-mounted device 61 which is spring-mounted by means of a spring device 60. The spring-mounted device is designed, as shown here, by the output or, alternatively, by one of the toothed parts or by one of the toothed part bearings. According to the invention, the actuator has a force measuring device 70, which force measuring device is designed to measure a mechanical force causing the movement of the output from a deflection of the spring-mounted device from a rest position, wherein the electronic operating circuit is designed to derive a drive efficiency of the actuator from force measurement values relating to the output movement and from measured values of a mechanical motor force derived from the motor current and/or motor voltage.

By comparing a propulsive force required for movement of the output, which is independent of the efficiency of the actuator, and a force applied or generated by the electric motor, the drive efficiency of the actuator can be inferred. Wear on the actuator can be detected from the measured drive efficiency, in particular from a change in the drive efficiency over time. If wear is detected or there is a long-term change in efficiency, the electronic operating circuit can be set up to issue a warning message, for example. In this way, a plant operator can replace an affected actuator if maintenance can be carried out on a plant without major inconvenience. This prevents expensive emergency shutdowns or malfunctions of the plant.

In one design, the force measuring device 70 of an exemplary actuator according to the invention is designed to convert a deflection of the spring-mounted device 61 from the rest position against the spring device 60 into a deflection-dependent measuring signal of an electronic measured variable such as inductance, capacitance, current or voltage, wherein the force measuring device or the electronic operating circuit 30 is set up to derive or calculate a measured value for the force from the measuring signal.

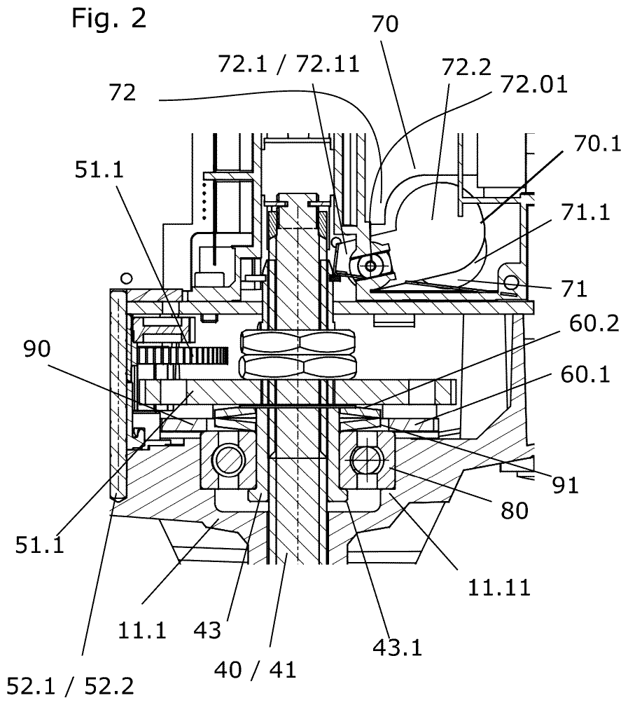

FIG. 2 shows a section of the cross-section of the actuator 1 shown in FIG. 1. The output 40 of the actuator 1 can comprise, as shown here, a spindle-shaped output axle 41 with a spindle nut 43, which spindle nut is driven via the gearbox by means of a gearwheel 51.1 in order to move the output shaft axially. The force measuring device can, as shown here, detect the axial movement of the output shaft, for example via the spindle nut 43, by means of a lever device 72 with a sensing arm 72.11.

The force measuring device as shown here by way of example has the lever device 72 with a lever bearing 72.01 and with a first end 72.1 and a second end 72.2, which is in particular opposite to the lever bearing, wherein the sensing arm forms the first end, wherein the second end is designed to influence a measured value of the electronic measured variable in a position-dependent manner, wherein a lever length of the first end is in particular smaller than a lever length of the second end.

A sensor 70.1 of the force measuring device is designed to generate a measuring signal corresponding to the propulsive force. A sensor element 71 of the sensor can have a front surface 71.1, wherein the second end 72.2 is set up to cover the front surface at least partially, wherein a coverage ratio is dependent on the propulsive force against the spring device and influences the measuring signal.

Measured values of the measuring signal assume a value range with a maximum value and a minimum value, wherein, in one design, a measured value of the measuring signal in a force-free state of the output assumes a value which is less than 30%, and in particular less than 25%, and preferably less than 20% of a difference between the maximum value and the minimum value from a mean value of the value range. In this way, a deflection of the spring-mounted device in both directions can be detected with sufficient detection clearance.

The spring device 60 may, as shown here, comprise at least a first spring element 60.1 and at least a second spring element 60.2, wherein the at least one first spring element is designed to exert a force against a deflection of the output 40 from the rest position in a first direction, wherein the at least one second spring element is designed to exert a force against a deflection of the output from the rest position into a second direction opposite to the first direction.

The spindle nut 43 can be mounted radially, as shown here, by means of a rolling bearing 80, which rolling bearing is at least partially arranged in a cylindrical recess 11.1 of the housing wall, wherein the cylindrical recess provides a stop 11. 11 for the rolling bearing against movement in the direction of a side of the cylindrical recess facing away from the housing, wherein the rolling bearing contacts the stop when the output 40 is in the rest position and/or is pretensioned against the stop, wherein the at least one first spring element 60.1 and the at least one second spring element 60.2 act against the rolling bearing on a side of the rolling bearing facing the housing, wherein the rolling bearing 80 is arranged in a cylindrical recess 11.1 of the housing wall 11. The cylindrical recess provides a stop 11.11 for the rolling bearing. A spring plate 90 fixed in the housing has a central opening 91 through which the spindle nut 43 is guided, wherein the spindle nut has a radial shaped part 43.1 on a side of the spring plate facing away from the housing, in particular a collar, which is set up to act directly or indirectly as a stop against the spring plate, wherein the spring plate is designed as one of the at least one first spring elements 60.1. The spring plate 90 is arranged outside the cylindrical recess 11.1, wherein the radial shaped part 43.1 acts against the spring plate via the rolling bearing 80. One of the toothed elements of the gearbox 50 is rotatably connected to the spindle nut 43, wherein the spring device 60 has at least one disc spring, which at least one disc spring surrounds the spindle nut and is designed as at least one of the at least one second spring element 60.2, wherein the at least one disc spring is arranged and clamped between the first toothed element and the rolling bearing. In this way, the spring device 60 can be implemented in a compact manner.

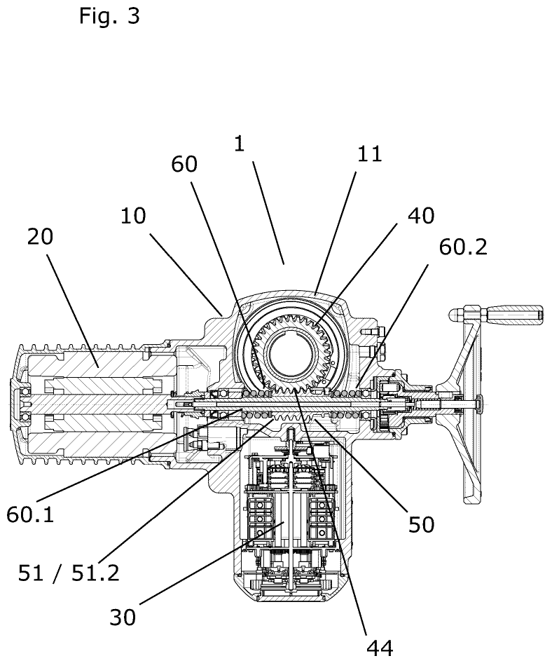

FIG. 3 shows a cross-section through an exemplary actuator 1, which can be equipped with a force measuring device according to the invention. The electric motor 20 is designed to drive an output 40 with a gearwheel 44 via a gearbox 50 with a worm 51.2 as a toothed part 51, wherein the worm is designed as a spring-mounted device 61 which is spring-mounted and clamped by a spring device 60 with a first spring element 60.1 and a second spring element 60.2 opposite relative to the worm. The worm engages in the gearwheel 44 and is deflected against the spring device in accordance with the propulsive force transmitted by the electric motor. According to the invention, a force measuring device can also be provided in this actuator, which detects the deflection of the worm against the spring device.

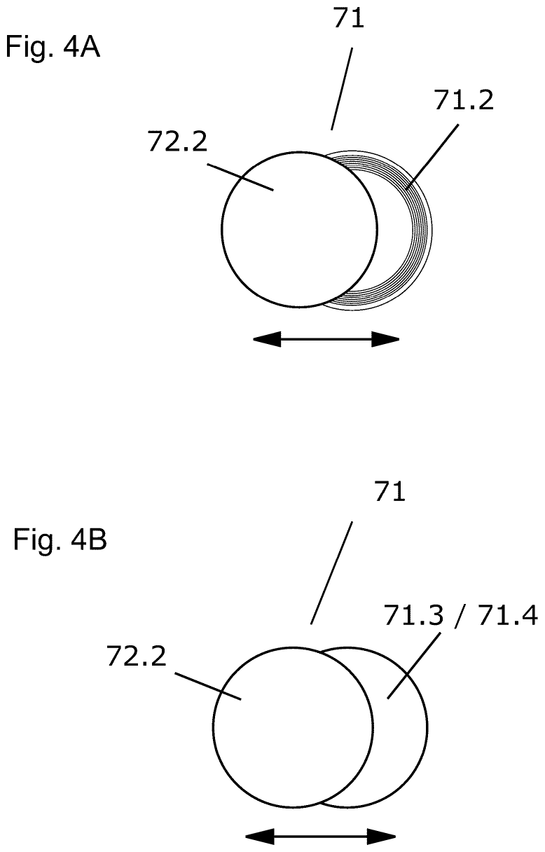

Sensor elements 71 are schematically outlined in FIGS. 4A and 4B. As shown in FIG. 4A, the sensor element can have a coil 71.2, the second end of which is permanently magnetic and/or electrically conductive, wherein the second end is designed to influence the inductance of the coil and the second end.

The sensor element may comprise a capacitor plate 71.3, as shown in FIG. 4B, wherein the second end is electrically conductive, wherein the second end is set up to influence a capacitance of the capacitor plate and the second end. Alternatively, the sensor element may comprise a photodiode 71.4, wherein the second end is designed to attenuate or block light incident thereon, for example generated by an LED.

The invention is not limited to the exemplary embodiments shown in FIGS. 1, 3, and 4; features of the exemplary embodiments may be exchanged with one another as technically appropriate.

### LIST OF REFERENCE SIGNS

1 Actuator
10 Housing
11 Housing wall
11.1 Cylindrical recess
11.1 Stop
20 Electric motor
30 Electronic operating circuit
40 Output
41 Output axle
42 Output shaft
43 Spindle nut
43.1 Radial shaped part
44 Gearwheel
50 Gearbox
51 Toothed parts
51.1 Gearwheel
51.2 Worm
52 Toothed part bearing
52.1 Gear axle
52.2 Gear shaft
60 Spring device
60.1 First spring element
60.2 Second spring element
61 Spring-mounted device
70 Force measuring device
70.1 Sensor
71 Sensor element
71.1 Front surface
71.2 Coil
71.3 Capacitor plate
71.4 Photodiode
72 Lever device
72.01 Lever bearing
72.1 First end
72.11 Sensing arm
72.2 Second end
80 Rolling bearing
90 Spring plate
91 Central opening

1. An actuator (1) for automation technology, actuate the actuator comprising:
a housing (10) with a housing wall (11);
an electric motor (20);
an electronic operating circuit (30) for operating the electric motor;
an output (40) having an output axle (41) or output shaft (42), said output is adapted to actuate a fitting by an axial movement or a rotary movement of the output axle or output shaft;
a gearbox (50) that is adapted to transmit a force or torque from the electric motor to the output, wherein the gear has a plurality of toothed parts (51) which are mounted by gear toothed part bearings (52);
wherein the electric motor, gearbox and electronic operating circuit are arranged in the housing,
wherein the electric motor is configured to move the output axially or rotatably via the gearbox,
wherein the actuator comprises a spring-mounted device (61) which is spring-mounted in the housing by a spring device (60), which spring-mounted device is formed by the output or by one of the toothed parts or by one of the gear toothed part bearings,
a force measuring device (70) configured to measure a mechanical propulsive force causing movement of the output from a deflection of the spring-mounted device from a rest position,
wherein the electronic operating circuit is configured to derive a drive efficiency of the actuator from force measurement values relating to the movement of the output and from measured values of a mechanical motor force derived from at least one of a motor current or motor voltage.

2. The actuator according to claim 1,
wherein the force measuring device (70) is set up to convert a deflection of the spring-mounted device (61) from the rest position against the spring (60) into a deflection-dependent measuring signal of an electronic measured variable, and
the force measuring device or the electronic operating circuit (30) is configured to derive or calculate the measured value for the mechanical propulsive force from the measuring signal.

3. The actuator according to claim 2,
wherein the force measuring device (70) has a sensor (70.1) for generating the measuring signal, and
the force measuring device has a sensing arm (72.11), which is set up to be moved by an axial or rotary movement of the spring-mounted device and thereby to cause a change in the measuring signal of the electronic measured variable.

4. The actuator according to claim 3,
wherein the force measuring device comprises a lever device (72) with a lever bearing (72.01) and with a first end (72.1) and an opposite second end (72.2) relative to the lever bearing,
the sensing arm forms the first end, wherein the second end is set up to influence a measured value of the electronic measured variable in a position-dependent manner, and
a lever length of the first end is smaller than a lever length of the second end.

5. The actuator according to claim 4,
wherein the sensor (70.1) has a sensor element (71) with a front surface (71.1),
the second end (72.2) is set up to at least partially cover the front surface,
with a coverage portion depending on the propulsive force against the spring device,
wherein a) the sensor element has a coil (71.2), the second end is permanently magnetic and/or electrically conductive, and the second end is set up to influence an inductance of the coil and the second end,
b) the sensor element comprises a capacitor plate (71.3), the second end is electrically conductive, and the second end is set up to influence a capacitance of the capacitor plate and the second end,
or c) the sensor element comprises a photodiode (71.4), and the second end is set up to attenuate or block light incident thereon.

6. The actuator according to claim 4, wherein the second end (72.2) is disc-shaped.

7. The actuator according to claim 2,
wherein measured values of the measuring signal have a value range with a maximum value and a minimum value,
the measured value of the measuring signal in a force-free state of the output assumes a value which is less than 30% of a difference between the maximum value and the minimum value from a mean value of the value range.

8. The actuator according to claim 1,
wherein the spring device (60) has at least one first spring element (60.1) and at least one second spring element (60.2),
the at least one first spring element is set up to exert a force against a deflection of the output (40) from the rest position in a first direction,
wherein the at least one second spring element is arranged to exert a force against a deflection of the spring-mounted device (61) from the rest position in a second direction opposite to the first direction.

9. The actuator according to claim 8,
wherein the at least one first spring element (60.1) and the at least one second spring element (60.2) surround the output, a cross-sectional plane of the first spring element and a cross-sectional plane of the second spring element are spaced apart by a distance of less than 30% of a diameter of the first spring element or the second spring element.

10. The actuator according to claim 9,
wherein the output axle (41) is formed as a threaded spindle,
the threaded spindle is fixed in rotation,
wherein the output has a spindle nut (43),
the electric motor (20) is set up to drive the spindle nut rotatably via the gearbox and thereby to move the threaded spindle axially, and
the output is spring-mounted in the housing in an axial direction of the threaded spindle by the spring device (60).

11. The actuator according to claim 10,
wherein the spindle nut (43) is mounted radially by a rolling bearing (80), which is at least partially arranged in a cylindrical recess (11.1) of the housing wall,
the cylindrical recess provides a stop (11.11) for the rolling bearing (80) against movement in a direction of a side of the cylindrical recess facing away from the housing,
the rolling bearing contacts the stop when the drive (40) is in the rest position and/or is pretensioned against the stop, and
the at least one first spring element (60.1) and the at least one second spring element (60.2) act against the rolling bearing on a side of the rolling bearing facing the housing.

12. The actuator according to claim 11,
wherein the actuator comprises a spring plate (90) fixed in the housing with a central opening (91), through which opening the spindle nut (43) is guided,
the spindle nut has a radial shaped part (43.1), on a side of the spring plate facing away from the housing, which is designed to act directly or indirectly as a stop against the spring plate, and
the spring plate forms one of the at least one first spring elements (60.1).

13. The actuator according to claim 11
wherein the spring plate (90) is arranged outside the cylindrical recess (11.1), and the radial shaped part (43.1) acts against the spring plate via the rolling bearing (80).

14. The actuator according to claim 12,
wherein a first of the toothed elements of the gearbox (50) is rotatably connected to the spindle nut (43),
the spring device (60) has at least one disc spring that surrounds the spindle nut and forms at least one of the at least one second spring element (60.2), and
the at least one disc spring is arranged and clamped between the first toothed element and the rolling bearing.
